(19) United States
(12) Patent Application Publication
(10) Pub. No.: US 2004/0055686 A1
(43) Pub. Date: Mar. 25, 2004

(54) Tire components having improved durability

(76) Inventors: Katharine M. Cowger, Orrville, OH (US); Charles D. Spragg, Hudson, OH (US)

Correspondence Address: Ms. Meredith E. Palmer, Bridgestone/Firestone Americas Holding, Inc., 1200 Firestone Parkway, Akron, OH, 44317, US

(21) Appl. No.: 10/624,388

(22) Filed: Jul. 22, 2003

Related U.S. Application Data
(63) Continuation of application No. 60/397,887, filed on Jul. 22, 2002.

(51) Int. Cl. B60C 17/00; B29C 73/22; B32B 3/26

(52) U.S. Cl. 152/516; 428/321.5; 264/4

(57) ABSTRACT

Tire components comprising a microencapsulated reactant and a reaction facilitator are provided. These components have the ability to resist crack propagation and to self-repair cracks that form within the tire component matrix.

This application claims benefit from U.S. Provisional Patent Application Serial No. 60/397,887, filed on Jul. 22, 2003.

### FIELD OF THE INVENTION

The present invention is directed toward tire components, including band elements, comprising a microencapsulated reactant and a reaction facilitator.

### BACKGROUND OF THE INVENTION

Tire components are subject to repetitive cycles of harsh conditions over a long period of time, and must provide reliable performance. Microcracking due to mechanical and thermal fatigue is a long-standing problem. Cracking leads to loss of structural strength and shortened life of the component.

Banded tires are pneumatic tires reinforced by a radially stabilized compression element, and can operate independently of air pressure. The compression element is commonly referred to as a band element.

The band element comprises a rigid composite containing resin and fiber. Band elements are typically subjected to high-cycle fatigue environments and are vulnerable to microcracks. Interlaminar shear stress is believed to be a major cause of cracking in band elements. Even in virgin specimens made by utilizing the best rigid composite fabrication techniques, some microcracks may be present. Relevant factors include fiber ratio, void volume, denier, tow design, and quality of fiber wetting. Techniques such as scanning electron microscopy can be used to detect microcracks.

Prior art attempts to improve interlaminar shear strength have focused on (a). band geometry; (b). band element configuration and internal layup; (c). driving many small rivets into the band element; (d). various fiber reinforcement techniques; and (e). toughening the resin matrix by using epoxy adhesives containing microballs. However, none of these techniques provide a way to prevent crack propagation, or to repair the cracks that occur.

Therefore, it would be advantageous to develop tire components, such as band elements, having the ability to resist cracking, or to repair cracks, thereby maintaining strength and durability.

### SUMMARY OF THE INVENTION

In general, the present invention provides a tire component comprising (1) a microencapsulated reactant and (2) a reaction facilitator.

The present invention further provides a process for forming tire components having improved durability, the process comprising the steps of: providing a tire component matrix; encapsulating a reactant to form microcapsules; selecting a reaction facilitator capable of facilitating the polymerization of the reactant; and adding the microcapsules and the reaction facilitator to the tire component matrix.

The present invention also provides a banded tire having a band element comprising (1) a microencapsulated reactant and (2) a reaction facilitator.

Advantageously, the present invention directly provides a tire component having the ability to prevent crack propagation and to self-repair microcracks. The tire component has improved durability and strength. Specifically, the present invention provides a banded tire having a band element that resists the cracking caused by interlaminar shear. Additionally, the tire component of the present invention provides viscoelastic components having the ability to resist and repair microcracks.

### DESCRIPTION OF THE DRAWINGS

FIG. 1 is a schematic view of a tire component matrix.

FIG. 2 is a cross-sectional view of the crown portion of a banded tire, seen along A-A.

FIG. 3 is a schematic view of the crown region of a banded tire.

FIG. 4 is a sectional schematic view of a band element.

FIG. 5 is an enlarged sectional view of a band element.

### DETAILED DESCRIPTION OF ILLUSTRATIVE EMBODIMENTS

The present invention is generally directed toward a tire component comprising a microencapsulated reactant and a reaction facilitator. The tire component of the present invention includes any of the standard components known in the art, such as band elements, tread, sidewalls, body plies, liners, cords, belts, and beads. The tire component comprises a matrix that may be rigid or viscoelastic. The matrix may be a composite material that comprises polymer resins, fillers, steel, aluminum, ceramic materials, or any of the other materials known in the art of tires. The tire component matrix preferably comprises thermoplastic or thermoset polymer resins, and includes polymer coatings for steel, aluminum, or ceramic materials.

In one preferred embodiment, the tire component comprises the band element of a banded tire. Banded tires include either a rigid or nearly rigid matrix. These non-extensible circular bands may formed from steel, aluminum, themoplastic resins, thermosetting resins, and multi-layered composites. The band is a radially stabilized compression element that allows operation of the tire independent of pressure. Banded tires are described more fully in U.S. Pat. Nos. 4,111,249, 4,318,434, 4,428,411, 4,456,048, 4,459,167, 4,673,014, 4,734,144, 4,794,966, 5,879,484, 6,122,791, 6,117,258, 6,148,885, 6,260,593, and 6,321,808, which are incorporated herein by reference.

In another embodiment, the tire component comprises a viscoelastic matrix. Tire components comprising a viscoelastic matrix as either a main component or as a coating include treads, sidewalls, body plies, liners, cords, belts, and beads. The viscoelastic matrix can comprise virtually any rubbery elastomer. Some specific examples of suitable rubbery elastomers include, but are not limited to, natural rubber, low-vinyl polybutadiene, cis-1,4-polybutadiene, amorphous 1,2-polybutadiene, low-vinyl polyisoprene, cis-1,4-polyisoprene, polyisobutylene, neoprene, ethylene-propylene copolymer rubber (EPR), styrene-butadiene rubber (SBR), styrene-isoprene rubber (SIR), styrene-isoprene-butadiene rubber (SIBR), styrene-butadiene-styrene block copolymer (SBS), styrene-butadiene block copolymer (SB), hydrogenated styrene-butadiene-styrene block copolymer (SEBS), hydrogenated styrene-butadiene block copolymer (SEB), styrene-isoprene-styrene block copolymer (SIS), styrene-isoprene block copolymer (SI), hydrogenated styrene-isoprene-styrene block copolymer (SEPS), hydrogenated styrene-isoprene block copolymer (SEP), polysulfide rubber, acrylic rubber, urethane rubber, silicone rubber, epichlorohydrin rubber, and the like. Mixtures of the above rubbery elastomers may also be used. These rubbery elastomers are well known and, for the most part, are commercially available.

The tire component of the present invention comprises a microencapsulated reactant dispersed within the matrix. The technique of microencapsulation is known. Generally, a shell of a microcapsule is formed of a synthetic resin material, and may be produced by well-known polymerization methods, such as interfacial polymerization, in-situ polymerization or the like. The diameter of microcapsules can vary widely, from a few microns up to a few hundred microns.

The shell of the microcapsule preferably has optimal geometry and mechanical properties. Relevant characteristics that will affect the performance of the microcapsule include the thickness of the shell wall, the toughness and relative stiffness of the shell, and the strength of the interface between the microcapsule and the tire component matrix. The shell wall must be strong enough to withstand the rigors of processing and normal use, but must be rupturable by a crack in the matrix. The tire component of the present invention may desirably comprise two or more different types of microcapsule shells, each characterized by varying strengths and ease of rupture. Furthermore, the shells may be selected to be more easily ruptured at certain temperatures or pressures.

In one preferred embodiment, the microcapsule shell is formed around the reactant by the in situ polymerization of urea and formaldehyde.

The encapsulated reactant comprises one or more appropriate monomers. Appropriate monomers are capable of polymerizing within the tire component matrix to form polymers that adhere to the crack surfaces and fill the cracks. Compatability with the matrix of the tire component will therefore have an effect on the selection of preferred monomers. Suitable monomers include conjugated diene monomers. Vinyl-substituted aromatic monomers can be copolymerized with one or more conjugated diene monomers to form rubbery elastomers. Some specific examples of suitable conjugated diene monomers that can be polymerized into rubbery elastomers include 1,3-butadiene, 2,3-dimethyl-1,3-butadiene, 2-phenyl-1,3-butadiene, 2-ethyl-1,3-butadiene, isoprene, 1,3-pentadiene, 2-methyl-1,3-pentadiene, 2,3-dimethyl-1,3-pentadiene, 3-methyl-1,3-pentadiene, 4-methyl-1,3-pentadiene, 1,3-hexadiene, 2,4-hexadiene, and 4,5-diethyl-1,3-octadiene. Some specific examples of suitable vinyl-substituted aromatic monomers that can be polymerized into rubbery elastomers include styrene, 4-methylstyrene, α-methylstyrene, 3,5-diethylstyrene, 4-ethylstyrene, 4-propylstyrene, 3,5-diethylstyrene, 2,4,6-trimethylstyrene, 4-dodecylstyrene, 2,3,4,5-tetraethylstyrene, 3-methyl-5-normal-hexylstyrene, 4-phenylstyrene, 2-ethyl-4-benzylstyrene, 3,5-diphenylstyrene, 1-vinylnaphthalene, 3-ethyl-1-vinylnaphthalene, 6-isopropyl-1-vinylnaphthalene, 6-cyclohexyl-1-vinylnapthalene, 7-dodecyl-2-vinylnaphthalene, and the like, and mixtures thereof. Cyclic monomers may also be used, such as dicyclopentadiene, cyclic ethers containing the tetrahydrofuran moiety, and monofuntional or multifunctional epoxides. The monofunctional epoxide compounds useful in this invention include phenyl glycidyl ether, cresyl glycidyl ether, and glycidyl ethers of alcohols such as dodecyl alcohol. The multifunctional epoxide compounds useful in this invention include epoxides of polyunsaturated organic compounds, oligomers of epihalohydrins, glycidyl derivatives of hydantoin and hydantoin derivatives, glycidyl ethers of polyvalent alcohols, glycidyl derivatives of triazines, and glycidyl ethers of polyhydric phenols. Glycidyl ethers of polyhydric phenols include the glycidyl ethers of dihydric phenols, including resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis(4-hydroxyphenyl)-propane (more commonly known as bisphenol A), and bis-(4-hydroxyphenyl)-methane (more commonly known as bisphenol F, and which may contain varying amounts of 2-hydroxyphenyl isomers), and the like. Other useful epoxy resins are cycloaliphatic epoxy resins and the epoxy novolac resins, which are the glycidyl ethers of novolac resins.

The tire component of the present invention further comprises a reaction facilitator embedded within the tire component matrix. As used within this specification, a reaction facilitator is a material that is capable of facilitating the polymerization of the reactant that is contained within the microcapsule once the microcapsule is penetrated and reactant is released into the component matrix. Suitable facilitators include catalysts, initiators, and other agents well-known in the art as useful in facilitating polymerization reactions.

In one preferred embodiment, the reaction facilitator is a polymerization catalyst embedded within the component matrix. The catalyst should be one that is capable of facilitating the polymerization of the encapsulated monomer. It will be understood that certain catalyst systems will effectively facilitate the polymerization of specific monomers, and the catalyst of the present invention should be selected accordingly.

Coordination catalyst systems, which are well known in the art, can be used for polymerizing the encapsulated monomer. For example, lanthamide-based catalyst systems comprising a lanthamide compound such as a neodymium compound, an alkylating agent, and a source of halogen are described in U.S. Pat. Nos. 3,297,667; 3,541,063; and 3,794,604, which are incorporated herein by reference. These lanthamide-based catalyst systems are useful for polymerizing conjugated diene monomers, and are particularly useful for facilitating the polymerization of 1,3-butadiene monomer into cis-1,4-polybutadiene rubber.

Anionic polymerization initiators, which are well known in the art, can also be used for polymerizing the encapsulated monomer. These initiators include, but are not limited to, organolithium initiators such as butyllithium or functional initiators such as lithium amide initiators, aminoalkyl lithium initiators, and organotin lithium initiators. Exemplary initiators are described in U.S. Pat. Nos. 5,153,159; 5,268,439; 5,274,106; 5,238,893; 5,332,810; 5,329,005; 5,578,542; 5,393,721; 5,491,230; 5,521,309; 5,496,940; 5,574,109; 5,523,364; 5,527,753; and 5,550,203, which are incorporated herein by reference. These initiators are particularly useful for synthesizing conjugated diene elastomers or copolymers of conjugated diene monomers and vinyl-substituted aromatic monomers.

Ring-opening metathesis by cationic or acid-catalyzed polymerization of cyclic monomers is a well-known process. Lewis acids are most typically used as facilitators, however Bronsted acids may also be employed.

In one preferred embodiment, the encapsulated reactant comprises dicyclopentadiene, and the catalyst comprises a ruthenium-based Grubb's catalyst.

Other facilitators that are useful for polymerizing monomers are known in the art, and the practice of this invention should not be limited to the selection of any particular reactant monomer or reaction facilitator.

Tire components are susceptible to damage in the form of cracks, and this leads to mechanical degradation and loss of strength. These cracks form deep within the microstructure of the matrix, where detection and treatment is difficult. The tire component of the present invention, however, is able to undergo self-repair to stop the propagation of cracks, and fill in cracks that have formed, thereby improving the durability of the component.

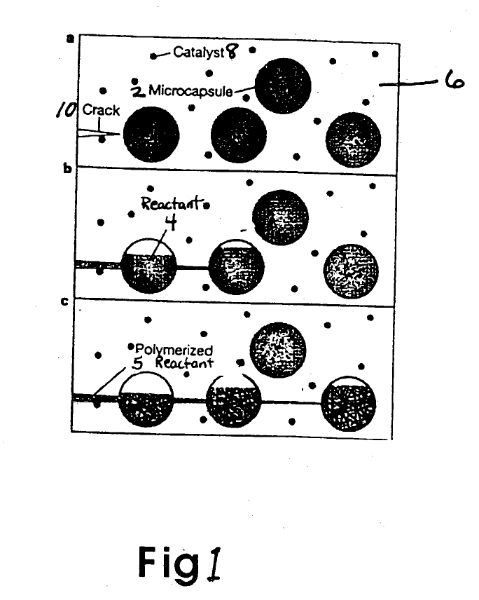

As illustrated in FIG. 1, microcapsules 2 containing reactant 4 are dispersed within a tire component matrix 6. Reaction facilitator 8 is embedded throughout the matrix 6. In FIG. 1(a), a crack 10 forms and begins to grow. In FIG. 1(b), the crack 10 penetrates some microcapsules 2, releasing reactant into the crack 10. In FIG. 1(c), the reactant 4 comes into contact with embedded reaction facilitator 8, and becomes polymerized reactant 5, bonding to the crack surfaces and filling the crack 10. If the reaction facilitator is a living catalyst having unterminated chain-ends, then the catalyst can facilitate polymerization of reactant from penetrated microcapsules multiple times.

Because crack propagation is prevented and microcracks are self-repaired, the tire component of the present invention has improved durability and strength. Therefore the present invention further provides a process for forming tire components having improved durability, the process comprising the steps of: encapsulating a reactant to form microcapsules; selecting a reaction facilitator capable of facilitating the polymerization of the reactant; and adding the microcapsules and reaction facilitator to a tire component matrix.

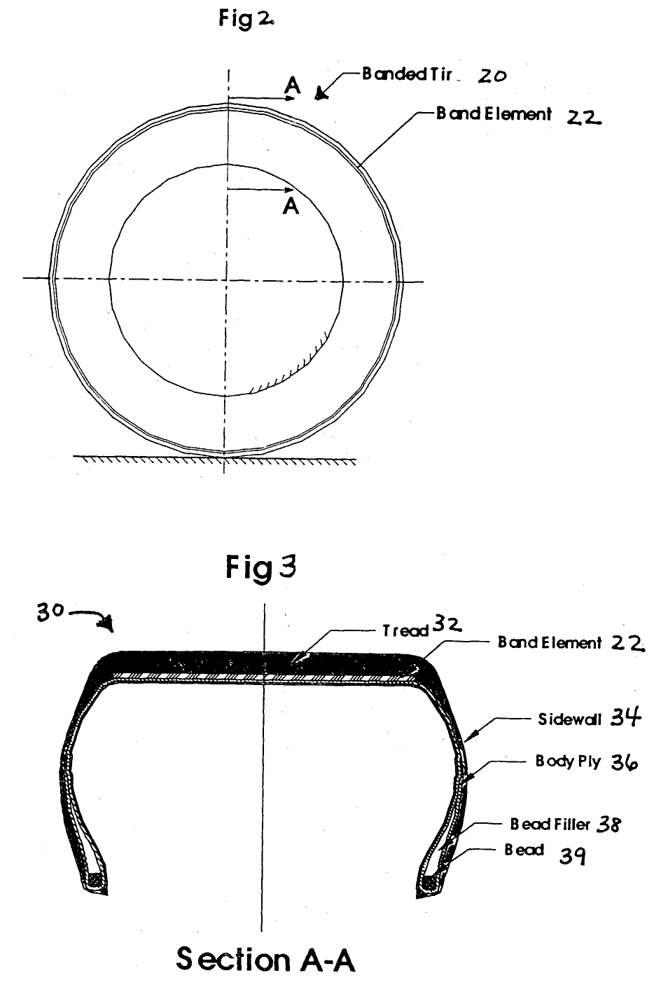

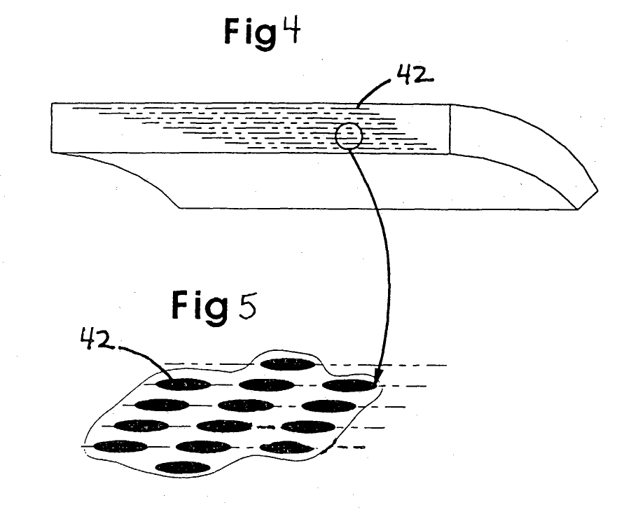

In one preferred embodiment, the tire component is a band element of a banded tire. FIG. 2 illustrates a banded tire 20 containing a band element 22. FIG. 3 further illustrates the components of the crown portion 30 of a banded tire, including the tread 32, sidewall 34, body ply 36, bead filler 38, bead 39, and band element 22. FIG. 4 illustrates the composite nature of the banded element 22, including fibers 42. FIG. 5 is an enlarged schematic view of a portion of the band element 22 of FIG. 4.

The band element preferably comprises a composite material containing various ingredients including resin and fibers. The microcapsules and reaction facilitator may be incorporated into the resin binder before or during preparation of the band element. Any of the following thermosetting methods can be employed: homogeneous filament winding, non-homogeneous filament winding, multilayer tape composite winding, winding with prepreg materials, winding with wet woven materials, winding with mats, winding with resin transfer (RTM) molding processes, winding with wet or prepreg woven preforms, and various combinations of the above.

The banded tire of the present invention has a band element comprising a microencapsulated reactant and a reaction facilitator. Any of the known geometries or configurations of banded tires-known in the art may be used. The banded tire of the present invention is useful in, but is not limited to, passenger banded tires, light truck banded tires, racing banded tires, and banded tires with or without tread patterns.

In another embodiment, the tire component of the present invention comprises viscoelastic components. Non-limiting examples of viscoelastic components of tires include those containing fabrics such as nylon, Kevlar, and polyester. These fabric components may further comprise coatings of natural or synthetic rubber. Viscoelastic components within the scope of the present invention also comprise coatings for metal cords, belts, and beads.

The microcapsules and reaction facilitator may be combined with the viscoelastic component during any of a number of stages of manufacture, including during the drawing or extrusion of the polymer for the fabrics, or with the liquid coating material prior to dipping or spraying.

Although the present invention has been described above with reference to particular means, materials and embodiments, it would be obvious to persons skilled in the art that various changes and modifications may be made, which fall within the scope claimed for the invention as set out in the appended claims. The invention is therefore not limited to the particulars disclosed and extends to all equivalents within the scope of the claims.

What is claimed is:

1. A tire component comprising: (1) a microencapsulated reactant and (2) a reaction facilitator.

2. A process for forming tire components having improved durability, the process comprising the steps of:
providing a tire component matrix;
encapsulating a reactant to form microcapsules;
selecting a reaction facilitator capable of facilitating the polymerization of the reactant; and
adding the microcapsules and the reaction facilitator to the tire component matrix.

3. A banded tire having a band element comprising: (1) a microencapsulated reactant and (2) a reaction facilitator.
